(19) United States
(12) Patent Application Publication
(10) Pub. No.: US 2023/0177955 A1
(43) Pub. Date: Jun. 8, 2023

(54) METHOD, APPARATUS AND COMPUTER PROGRAM PRODUCT FOR IDENTIFYING ROAD WORK SPEED FUNNELS WITHIN A ROAD NETWORK

(71) Applicant: HERE GLOBAL B.V., Eindhoven (NL)

(72) Inventors: Leon STENNETH, Chicago, IL (US); Bruce BERNHARDT, Chicago, IL (US)

(21) Appl. No.: 17/457,694

(22) Filed: Dec. 6, 2021

(51) Int. Cl. G08G 1/0967

(52) U.S. Cl. CPC G08G 1/096725; G08G 1/096791

(57) ABSTRACT

Embodiments described herein may provide a method for using vehicle probe data to identify speed funnels that are related to road construction. Methods may include: receiving probe data including sensor data from a probe apparatus collected along a sequence of road segments; determining, from the sensor data, if an indication of a start of road work has been detected; constructing a Finite State Automata (FSA) for the probe data collected along the sequence of road segments; determining, in the probe data, sensor data indicative of a sequence of speed limit value observations; identifying, using the FSA, a speed funnel based on a pattern of speed limit values within the sequence of speed limit value observations; and providing an indication of the speed funnel occurring within the sequence of road segments for at least one of navigational assistance or at least semi-autonomous vehicle control.

### TECHNOLOGICAL FIELD

An example embodiment of the present invention relates generally to detecting and identifying speed funnels within a road network, and more particularly, to a method, apparatus, and computer program product for using vehicle probe data to identify speed funnels that are related to road construction.

### BACKGROUND

Digital maps provide a detailed view of a road network and enable users to navigate among the road network with relative ease. Further, dynamic information such as traffic can provide additional details that help drivers navigate the road network efficiently. Beyond traffic, there are other factors that influence travel within a road network. Various hazard identification systems exist to identify potentially hazardous conditions such as road work conditions in a road network. Municipalities may publish road work events that can be used by traffic services and map data services to caution drivers of road work. These road work events generally involve little detail and often include tentative, planned schedules where the schedules may not account for various events that may impact scheduling.

Road work details within map data may not be temporally relevant, and may lag actual events due to the refresh rate of map data. Further, the dynamic nature of road work events presents challenges to map data service providers.

### BRIEF SUMMARY

A method, apparatus, and computer program product are therefore provided for detecting and identifying speed funnels within a road network, and more particularly, to a method, apparatus, and computer program product for using vehicle probe data to identify speed funnels that are related to road construction. An apparatus may be provided including at least one processor and at least one non-transitory memory including computer program code instructions, the computer program code instructions may be configured to, when executed, cause the apparatus to at least: receive probe data including sensor data from a probe apparatus collected along a sequence of road segments; determine, from the sensor data, if an indication of a start of road work has been detected; construct a Finite State Automata (FSA) for the probe data collected along the sequence of road segments; determine, in the probe data, sensor data indicative of a sequence of speed limit value observations; identify, using the FSA, a speed funnel based on a pattern of speed limit values within the sequence of speed limit value observations; and provide an indication of the speed funnel occurring within the sequence of road segments for at least one of navigational assistance or at least semi-autonomous vehicle control.

According to some embodiments, the speed funnel includes a starting location within the sequence of road segments and an ending location within the sequence of road segments. The pattern of speed limit values within the sequence of speed limit value observations includes, in certain embodiments: a first speed limit value having a first location along the sequence of road links; a second speed limit value at a second location along the sequence of road links; a third speed limit value at a third location along the sequence of road links; and a fourth speed limit value at a fourth location along the sequence of road links, where the second speed limit value is at least a predetermined value below the first speed limit value, the third speed limit value is at least a predefined value below the second speed limit value, and the fourth speed limit value is equal to or greater than the first speed limit value.

According to some embodiments, the apparatus is further caused to determine the first location to be a starting location of the speed funnel; and determine the fourth location to be an ending location of the speed funnel. The pattern of speed limit values within the sequence of speed limit value observations requires, in some embodiments, the first location to be within a predefined distance of the second location, the second location to be within a predefined distance of the third location, and the fourth location to be within a predefined distance of the third location. According to some embodiments, causing the apparatus to determine, from the probe data, if an indication of a start of road work has been detected includes causing the apparatus to: identify, in the sensor data, an indication of a start of road work, where the indication of the start of road work includes at least one of a sign or a road work object. The apparatus of an example embodiment is further caused to determine a confidence of a presence of the speed funnel within the sequence of road segments based on aggregated probe data from a plurality of probe apparatuses collected along the sequence of road segments, where causing the apparatus to provide the indication of the speed funnel occurring within the sequence of road segments includes causing the apparatus to provide the confidence of the presence of the speed funnel.

Embodiments provided herein include a computer program product including at least one non-transitory computer-readable storage medium having computer-executable program code instructions stored therein, the computer-executable program code instructions including program code instructions to: receive probe data including sensor data from a probe apparatus collected along a sequence of road segments; determine, from the sensor data, if an indication of a start of road work has been detected; construct a Finite State Automata (FSA) for the probe data collected along the sequence of road segments; determine, in the probe data, sensor data indicative of a sequence of speed limit value observations; identify, using the FSA, a speed funnel based on a pattern of speed limit values within the sequence of speed limit value observations; and provide an indication of the speed funnel occurring within the sequence of road segments for at least one of navigational assistance or at least semi-autonomous vehicle control.

According to some embodiments, the speed funnel includes a starting location within the sequence of road segments and an ending location within the sequence of road segments. The pattern of speed limit values within the sequence of speed limit value observations includes, in certain embodiments: a first speed limit value having a first location along the sequence of road links; a second speed limit value at a second location along the sequence of road links; a third speed limit value at a third location along the sequence of road links; and a fourth speed limit value at a fourth location along the sequence of road links, where the second speed limit value is at least a predetermined value below the first speed limit value, the third speed limit value is at least a predefined value below the second speed limit value, and the fourth speed limit value is equal to or greater than the first speed limit value.

According to some embodiments, the computer program product further includes program code instructions to: determine the first location to be a starting location of the speed funnel; and determine the fourth location to be an ending location of the speed funnel. The pattern of speed limit values within the sequence of speed limit value observations requires, in some embodiments, the first location to be within a predefined distance of the second location, the second location to be within a predefined distance of the third location, and the fourth location to be within a predefined distance of the third location. According to some embodiments, the program code instructions to determine, from the probe data, if an indication of a start of road work has been detected includes program code instructions to: identify, in the sensor data, an indication of a start of road work, where the indication of the start of road work includes at least one of a sign or a road work object. The computer program product of an example embodiment further includes program code instructions to determine a confidence of a presence of the speed funnel within the sequence of road segments based on aggregated probe data from a plurality of probe apparatuses collected along the sequence of road segments, where the program code instructions to provide an indication of the speed funnel occurring within the sequence of road segments includes program code instructions to provide the confidence of the presence of the speed funnel.

Embodiments provided herein include a method including: receiving probe data including sensor data from a probe apparatus collected along a sequence of road segments; determining, from the sensor data, if an indication of a start of road work has been detected; constructing a Finite State Automata (FSA) for the probe data collected along the sequence of road segments; determining, in the probe data, sensor data indicative of a sequence of speed limit value observations; identifying, using the FSA, a speed funnel based on a pattern of speed limit values within the sequence of speed limit value observations; and providing an indication of the speed funnel occurring within the sequence of road segments for at least one of navigational assistance or at least semi-autonomous vehicle control.

According to some embodiments, the speed funnel includes a starting location within the sequence of road segments and an ending location within the sequence of road segments. The pattern of speed limit values within the sequence of speed limit value observations includes, in certain embodiments: a first speed limit value having a first location along the sequence of road links; a second speed limit value at a second location along the sequence of road links; a third speed limit value at a third location along the sequence of road links; and a fourth speed limit value at a fourth location along the sequence of road links, where the second speed limit value is at least a predetermined value below the first speed limit value, the third speed limit value is at least a predefined value below the second speed limit value, and the fourth speed limit value is equal to or greater than the first speed limit value.

According to some embodiments, the method further includes determining the first location to be a starting location of the speed funnel; and determining the fourth location to be an ending location of the speed funnel. The pattern of speed limit values within the sequence of speed limit value observations requires, in some embodiments, the first location to be within a predefined distance of the second location, the second location to be within a predefined distance of the third location, and the fourth location to be within a predefined distance of the third location. According to some embodiments, determining, from the probe data, if an indication of a start of road work has been detected includes: identifying, in the sensor data, an indication of a start of road work, where the indication of the start of road work includes at least one of a sign or a road work object. The method of an example embodiment further includes determining a confidence of a presence of the speed funnel within the sequence of road segments based on aggregated probe data from a plurality of probe apparatuses collected along the sequence of road segments, where providing the indication of the speed funnel occurring within the sequence of road segments includes providing the confidence of the presence of the speed funnel.

Embodiments provided herein include an apparatus including: means for receiving probe data including sensor data from a probe apparatus collected along a sequence of road segments; means for determining, from the sensor data, if an indication of a start of road work has been detected; means for constructing a Finite State Automata (FSA) for the probe data collected along the sequence of road segments; means for determining, in the probe data, sensor data indicative of a sequence of speed limit value observations; means for identifying, using the FSA, a speed funnel based on a pattern of speed limit values within the sequence of speed limit value observations; and means for providing an indication of the speed funnel occurring within the sequence of road segments for at least one of navigational assistance or at least semi-autonomous vehicle control.

According to some embodiments, the speed funnel includes a starting location within the sequence of road segments and an ending location within the sequence of road segments. The pattern of speed limit values within the sequence of speed limit value observations includes, in certain embodiments: a first speed limit value having a first location along the sequence of road links; a second speed limit value at a second location along the sequence of road links; a third speed limit value at a third location along the sequence of road links; and a fourth speed limit value at a fourth location along the sequence of road links, where the second speed limit value is at least a predetermined value below the first speed limit value, the third speed limit value is at least a predefined value below the second speed limit value, and the fourth speed limit value is equal to or greater than the first speed limit value.

According to some embodiments, the apparatus further includes means for determining the first location to be a starting location of the speed funnel; and means for determining the fourth location to be an ending location of the speed funnel. The pattern of speed limit values within the sequence of speed limit value observations requires, in some embodiments, the first location to be within a predefined distance of the second location, the second location to be within a predefined distance of the third location, and the fourth location to be within a predefined distance of the third location. According to some embodiments, the means for determining, from the probe data, if an indication of a start of road work has been detected includes: means for identifying, in the sensor data, an indication of a start of road work, where the indication of the start of road work includes at least one of a sign or a road work object. The apparatus of an example embodiment further includes means for determining a confidence of a presence of the speed funnel within the sequence of road segments based on aggregated probe data from a plurality of probe apparatuses collected along the sequence of road segments, where the means for providing the indication of the speed funnel occurring within the sequence of road segments includes means for providing the confidence of the presence of the speed funnel.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus according to an example embodiment of the present disclosure;

FIG. 2 is a block diagram of a system for using probe data to identify speed funnels associated with road work according to an example embodiment of the present disclosure;

FIG. 3 is a diagram of a Finite State Automata for identifying speed funnels within a road network according to an example embodiment of the present disclosure;

FIG. 4 is a diagram illustrating a road including speed limit signs interpreted as a speed funnel according to an example embodiment of the present disclosure; and

FIG. 5 is a flowchart of another method for using vehicle probe data to identify speed funnels that are related to road construction according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment of the present invention for detecting and identifying speed funnels within a road network, and more particularly, to a method, apparatus, and computer program product for using vehicle probe data to identify speed funnels that are related to road construction. Embodiments described herein collect probe data from a plurality of vehicles to identify where road work exists within a road network and identify speed funnels associated with the road work. In this regard, according to certain embodiments, user interface of a device, such a mobile device or a device affixed to a vehicle, such as to a dashboard or the like, may provide work zone warnings to a user, which may aid the user in navigation or driving in an instance in which the user is traveling by vehicle. According to other embodiments described herein, road work is identified along road segments of a road network through the aggregation of probe data from vehicles traveling along the road segments of the road network.

Speed funnels, as described herein, are areas within a road network where permitted speed is incrementally reduced. Speed funnels reduce the speed limit along road segments in stages until the target speed limit is reached. Speed funnels are intended for temporary use around road work sites to bring traffic from higher speeds to relatively lower speeds around construction where traffic patterns may change, and workers may be present. In some instances, speed funnels are used permanently when approaching bottlenecks or transitioning between road functional classes. The purpose of speed funnels is to incrementally reduce traffic speed rather than an abrupt or large single speed change that can be problematic.

A work zone, as described herein, includes an area within which work or construction is being performed that affects, in at least one manner, travel along a road segment. Work or construction need not be actively occurring (e.g., work crews on-site) for a work zone to be considered a work zone. Further, the work or construction that is being performed need not be on a road along which a work zone is defined, as work performed proximate a road segment may affect a road segment sufficiently for the road segment to be identified as having a work zone along the road segment. For example, while work may be performed on a shoulder of a road or even on a building or landscape adjacent to a road segment, the road segment may be impacted by the work. With workers operating adjacent to a road segment, vehicle speeds may be reduced along the road segment to safeguard the workers and increase driver awareness in the area. This is accomplished in example embodiments with speed funnels that approach the work zone.

Because of the dynamic nature of work zones, and road work events that involve work zones, such work zones and speed funnels approaching work zones may not be adequately represented within map data that is updated periodically. Some work zones and associated speed funnels occur only during certain times of day, while others can be persistent for months. Further, the way in which road segments are affected by work zones can change frequently. For example, in some instances, work zone speed limits may only be present during such time as workers are present. Work zones may change the number and position of open lanes along a road segment. For these reasons, conventional map data is not well equipped to handle regularly changing work zones and the details thereof that impact traffic flow, routing, and autonomous vehicle control around the area of the work zone including the speed funnels used in an approach to a work zone.

Provided herein is a method, apparatus, and computer program product to detect and identify speed funnels that are related to or associated with road work using aggregated vehicle probe data to identify where road work exists within a road network and the presence of a speed funnel approaching the road network. Once the speed funnel and the road work has been identified, the affected region can be determined. The location of the speed funnel and road work can be communicated to travelers within the road network to take necessary precautions or to avoid road work as appropriate. A driver of a vehicle using navigational assistance or an autonomous vehicle itself can determine how to proceed based on the presence of the speed funnel and road work. An autonomous vehicle, for example, may determine that manual driving is necessary as a speed funnel is approached such that vehicle control is handed off to a driver. Alternatively, an autonomous vehicle can determine a best path through the area in which speed funnel and road work is present and proceed accordingly employing any work zone specific requirements, such as lower speed limits as they progress through the speed funnel, no passing, etc.

As described herein, example embodiments of the claims detect and identify speed funnels associated road work along road segments of a road network. The presence of the speed funnels, road work and the location thereof may be provided to a user via any available device, such as a mobile phone, tablet computer, fixed computer (e.g., desktop computer), or the like. Optionally, the speed funnel and road work information may be provided to autonomous or semi-autonomous vehicle controls to aid the autonomous controls in providing safe travel along a road network where road work exists. One example embodiment that will be described herein includes a user device of a user traveling in a vehicle. Such a device may be a mobile personal device that a user may use within a vehicle and outside of a vehicle environment, while other devices may include a vehicle navigation system. In some embodiments, the mobile personal device may double as a vehicle navigation system.

While the term “navigation system” is used herein to describe a device used to present map data, traffic data, etc., it is to be appreciated that such a navigation system can be used via a user interface without providing route guidance information. Route guidance is provided in response to a user entering a desired destination, and where a route between the origin or current location of a user and the destination is mapped and provided to the user. A navigation system may be used in the absence of a discrete destination to provide driver assistance and information. For example, as a user travels within a road network, a driver may be made aware of an upcoming speed funnel and road work such that they can take any necessary precautions, or avoid the area altogether.

In example embodiments, a navigation system user interface may be provided for driver assistance for a user traveling along a network of roadways. Optionally, embodiments described herein may provide assistance for autonomous or semi-autonomous vehicle control. Autonomous vehicle control may include driverless vehicle capability where all vehicle functions are provided by software and hardware to safely drive the vehicle along a path identified by the vehicle. Semi-autonomous vehicle control may be any level of driver assistance from adaptive cruise control, to lane-keep assist, or the like.

Autonomous and semi-autonomous vehicles are classified according to the Society of Automotive Engineers (SAE) to include six distinct levels of autonomy ranging from Level 0 to Level 5. In Level 0, a vehicle may provide warnings and may momentarily intervene (e.g., anti-lock braking or stability control), but has no sustained vehicle control. Level 1 autonomy includes a “hands on” control, where the driver and the automated system share control of the vehicle. Examples include adaptive cruise control (ACC) where the driver controls steering and the automated system controls speed. The driver must be ready to retake full control at any time with Level 1 autonomy. Level 2 autonomy is “hands off” control, where the system takes full control of the vehicle including accelerating, braking, and steering. The driver must monitor the driving and be prepared to intervene at any time if the automated system fails to respond properly. A driver may be required to maintain hands on a steering wheel in this level of autonomy despite the name as the driver must be ready to intervene when appropriate.

Level 3 vehicle autonomy includes “eyes off” whereby a driver can safely turn their attention away from the driving tasks. For example, a driver of a Level 3 autonomous vehicle can watch a movie or use a mobile device. While the vehicle will handle situations that call for immediate response like emergency braking, the driver must be prepared to intervene within some limited time specified by the manufacturer when called upon to do so. Level 4 autonomous control requires no driver attention for safety and a driver can even leave a driver's seat. Self-driving is supported only in limited spatial areas that may be geofenced or under special circumstances, like traffic jams. Level 5 autonomy is “steering wheel optional” autonomy. This includes true driverless vehicles that do not require a human.

Autonomous and semi-autonomous vehicles may use HD maps and an understanding of the context (e.g., traffic, weather, road construction, etc.) to help navigate and to control a vehicle along its path. In an instance in which a vehicle is subject to complete or partial autonomous control, identifying the location of a speed funnel approaching a road work zone may inform the vehicle enabling appropriate actions to be taken. Those actions may include re-routing to avoid or partially avoid the speed funnel and road work, or to alter the operational state of the vehicle according to the speed funnel and road work. Such operational state adjustments may include transitioning from autonomous control to manual control of the vehicle, increasing a sensor refresh rate in anticipation of potential rapid changes in the environment, or the like.

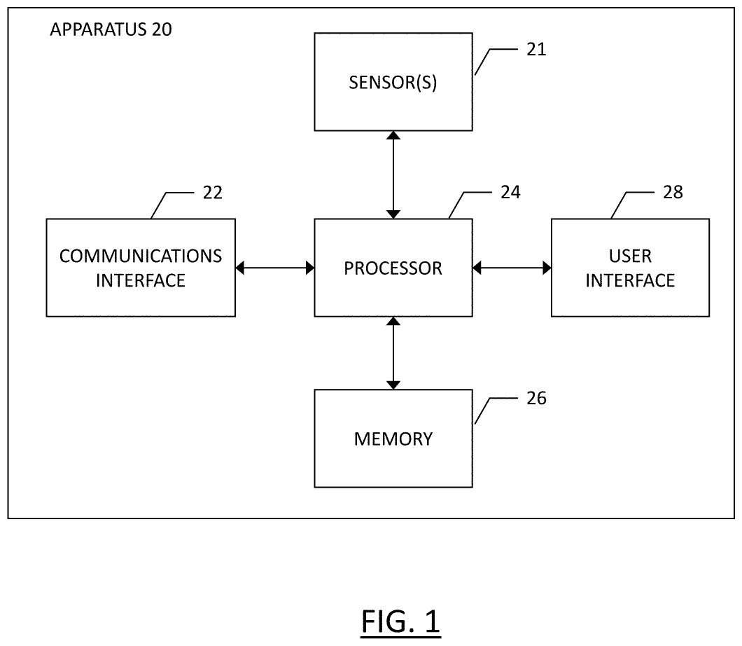

FIG. 1 is a schematic diagram of an example apparatus configured for performing any of the operations described herein. Apparatus 20 is an example embodiment that may be embodied by or associated with any of a variety of computing devices that include or are otherwise associated with a device configured for aggregating probe data to detect road work and generating, from the road work, an indication of the road work presence along one or more road segments of a road network to inform navigational systems and autonomous vehicles. For example, the computing device may be a mobile terminal, such as a personal digital assistant (PDA), mobile telephone, smart phone, personal navigation device, smart watch, tablet computer, camera, or any combination of the aforementioned and other types of voice and text communications systems. Optionally, the computing device may be a fixed computing device, such as a built-in vehicular navigation device, assisted driving device, or the like.

Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 20 may be equipped with any number of sensors 21, such as a global positioning system (GPS), Light Distancing and Ranging (LiDAR) sensor, humidity sensor, image capture sensor, precipitation sensor, accelerometer, and/or gyroscope. Any of the sensors may be used to sense information regarding the movement, positioning, or orientation of the device and for determining a weather condition at the location of the device as described herein according to example embodiments. In some example embodiments, such sensors may be implemented in a vehicle or other remote apparatus, and the information detected may be transmitted to the apparatus 20, such as by near field communication (NFC) including, but not limited to, Bluetooth™ communication, or the like.

The apparatus 20 may include, be associated with, or may otherwise be in communication with a communication interface 22, processor 24, a memory device 26 and a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 24 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 24 may be configured to execute instructions stored in the memory device 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, physical buttons, and/or other input/output mechanisms. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 26, and/or the like).

The apparatus 20 of an example embodiment may also optionally include a communication interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE). In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication may alternatively support vehicle to vehicle or vehicle to infrastructure wireless links.

According to certain embodiments, the apparatus 20 may support a mapping or navigation application so as to present maps or otherwise provide navigation or driver assistance. In order to support a mapping application, the computing device may include or otherwise be in communication with a geographic database, such as may be stored in memory device 26. For example, the geographic database includes node data records, road segment or link data records, point of interest (POI) data records, and other data records. More, fewer, or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology may be used, such as electronic horizon sensors, radar, LIDAR, ultrasonic and/or infrared sensors.

In example embodiments, a user device user interface and/or navigation system user interface may be provided to provide information or driver assistance to a user traveling along a network of roadways. Devices and systems may receive an indication of a current location of the user, and any location based warnings such as speed funnels road work associated with the current location of the device and user. While a service provider may be specifically configured to provide location-based information to a user, such a service may be enhanced or improved through cooperation with other service providers that independently determine location based warnings regarding speed funnels and work zone areas.

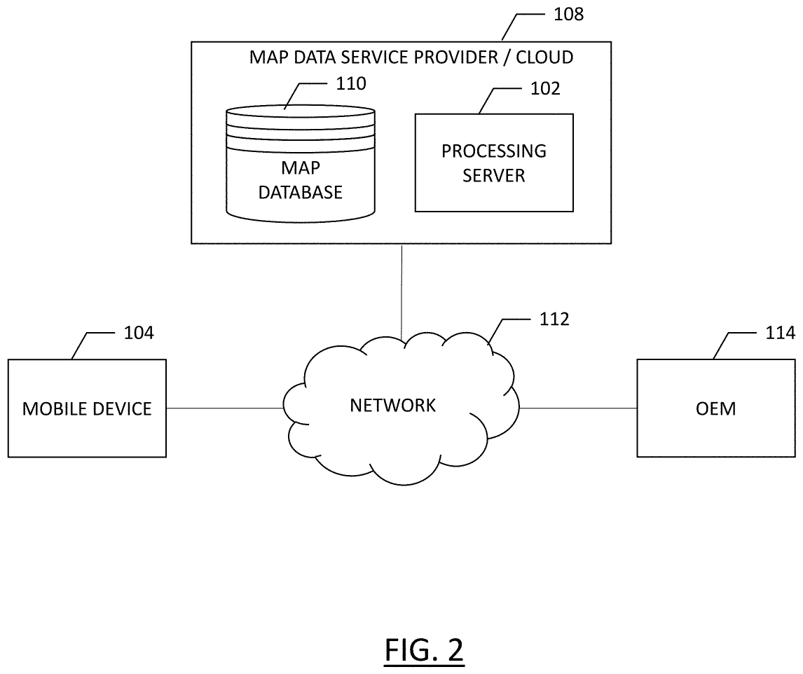

According to example embodiments, map service provider database may be used to provide driver assistance via a navigation system or in conjunction with autonomous vehicle control. FIG. 2 illustrates a communication diagram of an example embodiment of a system for implementing example embodiments described herein using a navigation system and a map data service provider. The illustrated embodiment of FIG. 2 includes a mobile device 104, which may be, for example, the apparatus 20 of FIG. 1, such as a mobile phone, an in-vehicle navigation system, or the like, an original equipment manufacturer (OEM) 114, and a map data service provider or cloud service 108. Each of the mobile device 104, OEM 114, and map data service provider 108 may be in communication with at least one of the other elements illustrated in FIG. 2 via a network 112, which may be any form of wireless or partially wireless network as will be described further below. Additional, different, or fewer components may be provided. For example, many mobile devices 104 may connect with the network 112. The map data service provider 108 may be cloud-based services and/or may operate via a hosting server that receives, processes, and provides data to other elements of the system.

The OEM 114 may include a server and a database configured to receive probe data from vehicles or devices corresponding to the OEM. For example, if the OEM is a brand of automobile, each of that manufacturer's automobiles (e.g., mobile device 104) may provide probe data to the OEM 114 for processing. That probe data may be encrypted with a proprietary encryption or encryption that is unique to the OEM. The OEM may be the manufacturer or service provider for a brand of vehicle or a device. For example, a mobile device carried by a user (e.g., driver or occupant) of a vehicle may be of a particular brand or service (e.g., mobile provider), where the OEM may correspond to the particular brand or service. The OEM may optionally include a service provider to which a subscriber subscribes, where the mobile device 104 may be such a subscriber. While depicted as an OEM 114 in FIG. 2, other entities may function in the same manner described herein with respect to the OEM. As such, the OEM 114 illustrated in FIG. 2 is not limited to original equipment manufacturers, but may be any entity participating as described herein with respect to the OEMs.

The map data service provider may include a map database 110 that may include node data, road segment data or link data, point of interest (POI) data, traffic data or the like. The map database 110 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 110 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 110 can include data about the POIs and their respective locations in the POI records. The map database 110 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 110 can include event data (e.g., traffic incidents, construction activities, scheduled events, unscheduled events, etc.) associated with the POI data records or other records of the map database 110.

The map database 110 may be maintained by a content provider e.g., the map data service provider and may be accessed, for example, by the content or service provider processing server 102. By way of example, the map data service provider can collect geographic data and dynamic data to generate and enhance the map database 110 and dynamic data such as traffic-related data or location-based road work event data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LIDAR, can be used to generate map geometries directly or through machine learning as described herein. However, the most ubiquitous form of data that may be available is vehicle data provided by vehicles, such as mobile device 104, as they travel the roads throughout a region. These vehicles or probes may be embodied by mobile device 104 and may provide data to the map data service provider in the form of traffic speed/congestion data, weather information, location, speed, direction, etc.

The map database 110 may be a master map database stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 104, for example. The navigation-related functions can correspond to vehicle navigation, pedestrian navigation, or other types of navigation. While example embodiments described herein generally relate to vehicular travel along roads, example embodiments may be implemented for pedestrian travel along walkways, bicycle travel along bike paths, boat travel along maritime navigational routes, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

The OEM 114 may be configured to access the map database 110 via the processing server 102 through, for example, a mapping application, such that the user equipment may provide navigational assistance to a user among other services provided through access to the map data service provider 108. According to some embodiments, the map data service provider 108 may function as the OEM, such as when the map data service provider is a service provider to OEMs to provide map services to vehicles from that OEM. In such an embodiment, map data service provider 108 may or may not be the recipient of vehicle probe data from the vehicles of that manufacturer. Similarly, the map data service provider 108 may provide services to mobile devices, such as a map services provider that may be implemented on a mobile device, such as in a mapping application. According to such an embodiment, the map data service provider 108 may function as the OEM as the map developer receives the probe data from the mobile devices of users as they travel along a road network.

As mentioned above, the map data service provider 108 map database 110 may be a master geographic database, but in alternate embodiments, a client side map database may represent a compiled navigation database that may be used in or with end user devices (e.g., mobile device 104) to provide navigation and/or map-related functions. For example, the map database 110 may be used with the mobile device 104 to provide an end user with navigation features. In such a case, the map database 110 can be downloaded or stored on the end user device which can access the map database 110 through a wireless or wired connection, such as via a processing server 102 and/or the network 112, for example.

In one embodiment, as noted above, the end user device or mobile device 104 can be embodied by the apparatus 20 of FIG. 1 and can include an Advanced Driver Assistance System (ADAS) which may include an infotainment in-vehicle system or an in-vehicle navigation system, and/or devices such as a personal navigation device (PND), a portable navigation device, a cellular telephone, a smart phone, a personal digital assistant (PDA), a watch, a camera, a computer, and/or other device that can perform navigation-related functions, such as digital routing and map display. An end user can use the mobile device 104 for navigation and map functions such as guidance and map display, for example, and for determination of useful driver assistance information, according to some example embodiments. An embodiment implemented as an ADAS may at least partially control autonomous or semi-autonomous features of a vehicle with the assistance of establishing the vehicle.

An ADAS may be used to improve the comfort, efficiency, safety, and overall satisfaction of driving. Examples of such advanced driver assistance systems include semi-autonomous driver assistance features such as adaptive headlight aiming, adaptive cruise control, lane departure warning and control, curve warning, speed limit notification, hazard warning, predictive cruise control, adaptive shift control, among others. Other examples of an ADAS may include provisions for fully autonomous control of a vehicle to drive the vehicle along a road network without requiring input from a driver. Some of these advanced driver assistance systems use a variety of sensor mechanisms in the vehicle to determine the current state of the vehicle and the current state of the roadway ahead of the vehicle. These sensor mechanisms may include radar, infrared, ultrasonic, and vision-oriented sensors such as image sensors and light distancing and ranging (LiDAR) sensors.

Driver assistance information may be communicated to a user via a display, such as a display of user interface 28 of apparatus 20 of FIG. 1. The display may be a display of a mobile phone, or a screen of an in-vehicle navigation system, for example. In the presentation of the driver assistance information to the user it is important that the information is communicated clearly and in an easily understood manner such that a user may quickly understand the information presented. As a user of a navigation system may be driving a vehicle, it is important that the navigation information including driver assistance information is quickly and easily understood, without requiring substantial user interaction should additional information be needed by the driver.

Map information and dynamic content is provided in some embodiments by service providers, such as map data service provider 108 of FIG. 1. These services collect probe data from connected vehicles and aggregate the collected probe data to build high definition (HD) maps with road segment resolution down to, in some embodiments, centimeters, for an ADAS system to support autonomously controlled vehicles. The probe data collected from vehicles traveling within the road network includes sensor data, such as LiDAR, radar, ultrasonic sensors, cameras, geolocation, etc. Generally, ADAS dynamic content services include real time traffic, hazard warning, road signs, safety cameras, on-street parking, etc. Using backend sensor data and advanced wireless technologies (e.g., 4G and/or 5G or subsequent iterations), autonomous vehicle control can be improved through greater awareness of dynamic environmental factors.

Example embodiments provided herein provide a method of using probe data from vehicles traveling within a road network to identify where speed funnels begin and road work exists within the road network. Based on the identified speed funnels and road work, an indication of the speed funnels and road work, and the impact on the road segments along which the road work is occurring can be communicated to vehicles traveling within the road network to inform navigational systems and autonomous vehicles. Mobile devices, such as mobile device 104 may be associated with a particular service provider (e.g., OEM 114 and/or map data service provider 108) where dynamic information such as road work and locations thereof are communicated from that particular service provider to the mobile device, and used by the mobile device to present relevant information on a user interface and/or to inform vehicle automation regarding areas where a speed funnel and road work is determined to exist.

Speed funnels are a strong indicator of road work identified through probe data along roadways. Speed funnels detected by embodiments described herein facilitate road work detection. According to an example embodiment, vehicle sensor data in the form of probe data from probe apparatuses (e.g., probe apparatus 20 and/or mobile device 104) is extracted for a given period. This time period may include, for instance, over the course of a day, a week or a shorter time, such as an hour. The sensor data includes drive identifiers that identify the individual trajectories of probe apparatuses. The sensor data further includes identified signs (e.g., from image data, such as speed limit signs and start/end of construction signs), vehicle location, speed limit observation location, timestamp, etc. The drive identifier is a unique identifier of each vehicle's session and session lengths can be fixed or variable based on distance and time. The sensor observations for each drive can be sorted by timestamps.

For each drive identifier, embodiments analyze the sensor data generated to determine if the drive contains a detected posted sign that is related to construction or road work. These signs include “start of construction” signs and “end of construction” signs. If the drive does not contain an observation of a posted sign related to road construction, the drive is discarded and not used to determine the presence of a speed funnel. This filtering operation is performed as speed funnels can exist in other situations unrelated to road work. For example, a change in road functional classes as a highway ends, approaching congested areas on a highway (e.g., entering a city), or approaching a road section with tighter turns. Embodiments described herein are interested in speed funnels associated with road construction, such that this filtration operation reduces the likelihood of false positives.

While some embodiments rely on signs posted that explicitly indicate the start of construction or end of construction, objects can be identified that are interpreted as the start or end of construction. Objects that may be interpreted to indicate the start of construction include signs, where the signs may be static or variable signs. Static signs include signs such as “Work Zone” or “Lane Closed”, for example. Variable signs include lighted signs, such as those presenting words, and those presenting symbols or instructions, such as a flashing arrow sign. Objects can also include barricades, cones, barrels, or the like. According to some example embodiments described herein, the detection of the beginning of a road work zone is based on a probability of a sign or object being present that signifies the “start of construction.”

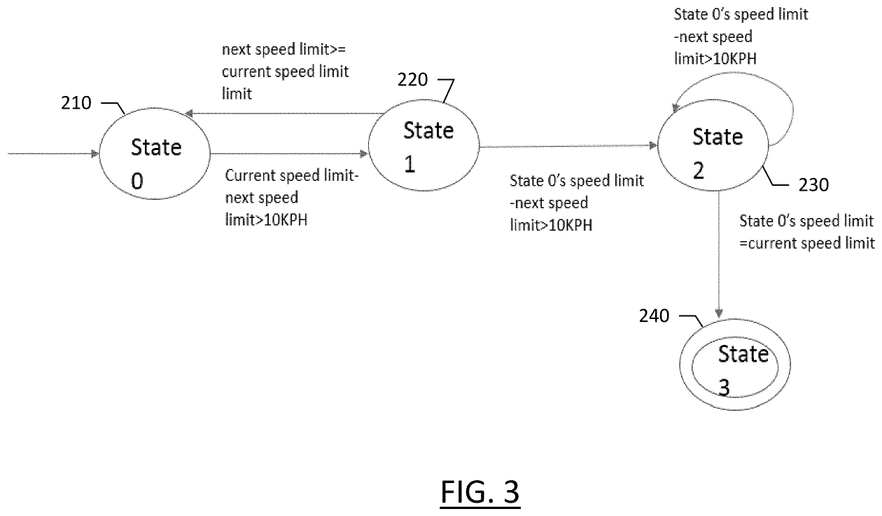

For each drive identifier that includes a drive along which a “start of construction” or “end of construction” sign or object was detected, a four state Finite State Automata (FSA) or Finite State Machine is formed as shown in FIG. 3. The FSA has a set of states and rules for moving from one state to another, but depends upon the applied input. The first and subsequent stages of the illustrated FSA are triggered by speed limit observation to determine the speed funnel along a road segment. As shown, the start state is zero at 210 and the final state is 3 at 240. Transitioning between states is based on a detected speed limit shown by the respective arrows. The FSA of FIG. 3 is constructed using only speed limit observations for the same drive identifier within a single time period. A speed limit difference of 10 kilometers per hour (kph) is selected based on sensor data and ground truth data.

The FSA of FIG. 3 provides a method of an example embodiment for detecting speed funnels on highways. An FSA is constructed for each drive that contains a start of construction sign or indication, as detailed above in the filtering stage. The FSA is used for a single probe apparatus associated with a drive identifier. The starting state is “State 0” at 210 and is triggered by the first posted speed limit value observation in the probe data from the probe apparatus associated with the drive identifier. The FSA moves to “State 1” at 220 in response to a current speed limit along the road being 10 kph or greater than a next identified posted speed limit value observation in the probe data from the probe apparatus. According to certain embodiments, a distance factor is included in the movement between states. For example, the speed limit sign observed to transition from “State 0” to “State 1” may be required to be within a predefined distance of the speed limit sign observed to enter “State 0”. This distance may be, for example, around one kilometer. While embodiments described herein use an incremental step of 10 kph, such a value is configurable. The incremental step may be based on a road functional class or a maximum speed for a particular road, as a road with a relatively high maximum speed limit may be expected to drop a greater increment of speed.

At “State 1”, a next speed limit value observation is used to establish where the FSA moves next. If the speed limit increases, the FSA returns to “State 0” at 210 as a speed funnel is not occurring, and the reduction in speed may have been for another, temporary reason along a particular stretch of roadway. If the speed limit value observation when at “State 1” decreases again by 10 kph or more, the FSA moves to “State 2” at 230. Again, a distance factor is employed in some embodiments whereby the speed limit sign observed to advance from “State 1” to “State 2” may be required to be within a predefined distance of the speed limit sign observed to advance from “State 0” to “State 1”. Optionally, the predefined distance may be established from the speed limit sign observed to enter “State 0”. If speed limit value observations continue to decline, the FSA remains in “State 2”. This occurs during the speed funnel. “State 3” is entered in response to a speed limit value observation resuming the speed limit value observation used to enter “State 0”. This signals the end of the speed funnel. The location, duration, and speed limit observations within the speed funnel can be reported, for example, by a map data service provider 108 to vehicles traveling along a route that would encounter the speed funnel, and for use in route generation to avoid the speed funnel where appropriate.

If a drive of the probe apparatus ends without the final state (State 3) of the FSA being reached, the FSA is forcefully terminated, and a conclusion is reached that the drive does not contain a speed funnel. If in “State 1” the next peed limit is greater or equal to the start state (State 0) speed limit, the FSA returns to “State 0”.

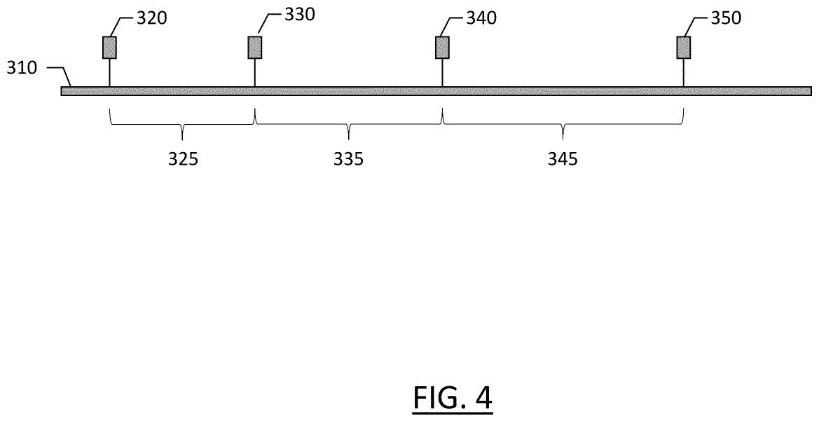

FIG. 4 is a diagram illustrating a road including speed limit signs interpreted as a speed funnel according to an example embodiment of the present disclosure. The embodiment of FIG. 4 described herein presumes a “start of construction” sign or indication has been detected already. A probe apparatus embodied as a vehicle traveling along a sequence of road segments 310 encounters a first speed limit sign 320. This speed limit sign is captured in a first speed limit value observation of a first speed limit value (e.g., 100 kph). Subsequently, a second speed limit sign 330 is encountered and a second speed limit value observation is made of the second speed limit value. Provided the speed limit value at the second speed limit sign 330 is at least a predetermined increment (e.g., 10 kph) below the speed limit value of the first speed limit sign 320, State 1 220 of the FSA is entered. This state is, in some embodiments, further predicated on the distance from the first speed limit sign 320 to the second speed limit sign 330 shown as distance 325 being less than a predefined amount, such as less than one kilometer.

A third speed limit sign 340 is encountered such that a third speed limit value observation is made. If the third speed limit value is again at least a predetermined increment below the second speed limit value, State 2 230 of the FSA is entered and it is more likely that a speed funnel is present. The location of the third speed limit sign 340 must be, in some embodiments, within a distance, shown as distance 335, from the second speed limit sign 340. A fourth speed limit sign 350 is encountered and a fourth speed limit value observation made. If the fourth speed limit value is equal to or greater than that of the first speed limit value, the speed funnel is confirmed and it is determined to have ended at 350. The fourth speed limit sign is required by some embodiments to be within a distance, shown as distance 345, of the third speed limit sign. In the example embodiment of FIG. 4, the speed funnel exists extending between the first speed limit sign 320 to the fourth speed limit sign 350 including distances 325, 335, and 345.

While four speed limit value observations are shown, any number of speed limit values may be observed. Referring back to the FSA of FIG. 3, State 2 at 230 may be entered and maintained for multiple speed limit value observations, where the speed limit either decreases or fails to increase. This can occur, for example, when there is a long period of road construction. With reference to FIG. 4, the third speed limit value observation of speed limit sign 340 may occur through numerous additional speed limit signs before speed limit sign 350 is reached whereby the speed limit returns to normal. Thus, while four speed limit value observations are described in a basic embodiment, embodiments can identify speed funnels over any number of speed limit signs over any distance.

Embodiments described herein detect speed funnels on a per-vehicle basis. The speed funnels detected by example embodiments can be map-matched on a per-vehicle basis to underlying map data to identify where the speed funnel exists. The confidence level of the presence of a speed funnel can be based on a number of vehicles reporting the speed funnel, and optionally on a proportion of sensor-equipped vehicles reporting a speed funnel in a specific location relative to all observations at that specific location. If a threshold proportion of sensor-equipped vehicles report the speed funnel, it can be established with higher confidence that a speed funnel is present.

Proportional thresholds can be variable and can be established based on learned behavior of when thresholds correspond with ground truth observations. For example, a proportion threshold can begin at 0.7 and can be improved with ground truth. Signals are computed only if there are at least a minimum number of vehicles having traversed a particular road segment. The proportion and the minimum number of vehicles can be varied based on specific location as certain countries, regions, localities may provide better signage or stronger indicators of the start of a construction zone and the speed funnel approaching the road work. Ground truth observations to verify or discredit the “start of construction” data or the presence of a speed funnel can be used to adjust proportional thresholds for different regions.

Embodiments described herein provide a method that uses probe data to accurately identify where speed funnels associated with road work exist within a road network. Once the speed funnel has been identified through the probe data, the affected road segments are identified. The affected road segments define the speed funnel and the work zone associated with the speed funnel. Embodiments detect the start of road work using sensor data from vehicles traveling within a road network. Using this data, the road work location and start/end time can be determined along with the speed funnel information approaching the road work. Using the speed funnel and associated road work location and start/end times, embodiments can identify where and when vehicular travel can be affected. Vehicles that are driven by a person can receive an indication of the speed funnel and road work, such as when the vehicle is approaching the speed funnel, or the speed funnel lies along a route that is being driven. The person driving the vehicle can take any necessary precautions, such as slowing down or avoiding the speed funnel and road work. Autonomous or semi-autonomous vehicles can receive an indication of the road work and take any necessary precautions automatically. For example, an autonomous vehicle may slow for the speed funnel, the road work, change lanes, or determine that autonomous control is not recommended and cede control to a driver for the duration of the road work.

Speed funnels as described herein provide an indication of road work. Traffic operators generally reduce speed limits in the vicinity of construction, and this reduction in speed limits causes the speed funnels. Since the traffic operators modify the speed limits on the road, speed limits in the map should become outdated, at least temporarily. Thus, each speed funnel that is detected by embodiments described herein is validated using the speed limits of the map. The speed funnel confirmation using a map's speed limit can be performed by comparing each speed limit within the map-matched speed funnel to its corresponding map speed limit at the link and direction of travel coinciding with the speed funnel. If a predetermined percentage of the speed limits within the speed funnel are lower than the map's speed limit, the speed funnel is detected and confirmed. The predetermined percentage is configurable, where an initial value used may include 30%, for example.

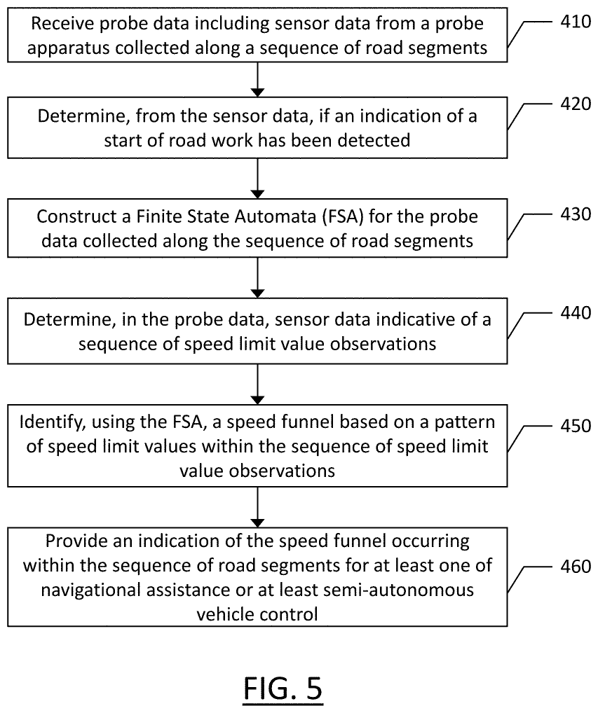

FIG. 5 is a flowchart illustrative of methods according to example embodiments of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 of the apparatus 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 5 illustrates a method for using vehicle probe data to identify speed funnels that are related to road construction. Probe data is received at 410 including sensor data from a probe apparatus collected along a sequence of road segments. This probe data is received from a drive of the probe apparatus (e.g., probe apparatus 20) along a sequence of road segments within a road network. From the sensor data, it is determined at 420 if there is an indication of a start of road work. This indication may be, for example, in the form of a road construction sign identified in sensor data, such as in an image from a camera of the probe apparatus. A Finite State Automata (FSA) is constructed at 430 for the probe data collected along the sequence of road segments in response to determining that there is an indication of the start of road work. At 440, it is determined from the probe data, sensor data indicative of a sequence of speed limit value observations. These observations include, for example, image sensor data identifying speed limit signs within the image. Using the FSA, a speed funnel is identified at 450 based on a pattern of speed limit values within the sequence of speed limit value observations. An indication of the speed funnel occurring within the sequence of road segments is provided at 460 for at least one of navigational assistances or at least semi-autonomous vehicle control.

In an example embodiment, an apparatus for performing the method of FIG. 5 above may include a processor (e.g., the processor 24) configured to perform some or each of the operations (410-460) described above. The processor may, for example, be configured to perform the operations (410-460) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 410-460 may comprise, for example, the processor 24 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one non-transitory memory including computer program code instructions, the computer program code instructions configured to, when executed, cause the apparatus to at least:
receive probe data including sensor data from a probe apparatus collected along a sequence of road segments;
determine, from the sensor data, if an indication of a start of road work has been detected;
construct a Finite State Automata (FSA) for the probe data collected along the sequence of road segments;
determine, in the probe data, sensor data indicative of a sequence of speed limit value observations;
identify, using the FSA, a speed funnel based on a pattern of speed limit values within the sequence of speed limit value observations; and
provide an indication of the speed funnel occurring within the sequence of road segments for at least one of navigational assistance or at least semi-autonomous vehicle control.

2. The apparatus of claim 1, wherein the speed funnel includes a starting location within the sequence of road segments and an ending location within the sequence of road segments.

3. The apparatus of claim 1, wherein the pattern of speed limit values within the sequence of speed limit value observations comprises:
a first speed limit value at a first location along the sequence of road links;
a second speed limit value at a second location along the sequence of road links;
a third speed limit value at a third location along the sequence of road links; and
a fourth speed limit value at a fourth location along the sequence of road links,
wherein the second speed limit value is at least a predetermined value below the first speed limit value, the third speed limit value is at least the predetermined value below the second speed limit value, and the fourth speed limit value is equal to or greater than the first speed limit value.

4. The apparatus of claim 3, wherein the apparatus is further caused to:
determine the first location to be a starting location of the speed funnel; and
determine the fourth location to be an ending location of the speed funnel.

5. The apparatus of claim 3, wherein the pattern of speed limit values within the sequence of speed limit value observations requires the first location to be within a predefined distance of the second location, the second location to be within a predefined distance of the third location, and the fourth location to be within a predefined distance of the third location.

6. The apparatus of claim 1, wherein causing the apparatus to determine, from the probe data, if an indication of a start of road work has been detected comprises causing the apparatus to:
identify, in the sensor data, an indication of a start of road work, wherein the indication of the start of road work comprises at least one of: a sign or a road work object.

7. The apparatus of claim 1, wherein the apparatus is further caused to:
determine a confidence of a presence of the speed funnel within the sequence of road segments based on aggregated probe data from a plurality of probe apparatuses collected along the sequence of road segments, wherein causing the apparatus to provide the indication of the speed funnel occurring within the sequence of road segments comprises causing the apparatus to provide the confidence of the presence of the speed funnel.

8. A computer program product comprising at least one non-transitory computer-readable storage medium having computer-executable program code instructions stored therein, the computer-executable program code instructions comprising program code instructions to:
receive probe data including sensor data from a probe apparatus collected along a sequence of road segments;
determine, from the sensor data, if an indication of a start of road work has been detected;
construct a Finite State Automata (FSA) for the probe data collected along the sequence of road segments;
determine, in the probe data, sensor data indicative of a sequence of speed limit value observations;
identify, using the FSA, a speed funnel based on a pattern of speed limit values within the sequence of speed limit value observations; and
provide an indication of the speed funnel occurring within the sequence of road segments for at least one of navigational assistance or at least semi-autonomous vehicle control.

9. The computer program product of claim 8, wherein the speed funnel includes a starting location within the sequence of road segments and an ending location within the sequence of road segments.

10. The computer program product of claim 8, wherein the pattern of speed limit values within the sequence of speed limit value observations comprises:
a first speed limit value at a first location along the sequence of road links;
a second speed limit value at a second location along the sequence of road links;
a third speed limit value at a third location along the sequence of road links; and
a fourth speed limit value at a fourth location along the sequence of road links,
wherein the second speed limit value is at least a predetermined value below the first speed limit value, the third speed limit value is at least the predetermined value below the second speed limit value, and the fourth speed limit value is equal to or greater than the first speed limit value.

11. The computer program product of claim 10, further comprising program code instructions to:
determine the first location to be a starting location of the speed funnel; and
determine the fourth location to be an ending location of the speed funnel.

12. The computer program product of claim 10, wherein the pattern of speed limit values within the sequence of speed limit value observations requires the first location to be within a predefined distance of the second location, the second location to be within a predefined distance of the third location, and the fourth location to be within a predefined distance of the third location.

13. The computer program product of claim 8, wherein the program code instructions to determine, from the probe data, if an indication of a start of road work has been detected comprise program code instructions to:
identify, in the sensor data, an indication of a start of road work, wherein the indication of the start of road work comprises at least one of: a sign or a road work object.

14. The computer program product of claim 8, further comprising program code instructions to:
determine a confidence of a presence of the speed funnel within the sequence of road segments based on aggregated probe data from a plurality of probe apparatuses collected along the sequence of road segments, wherein the program code instructions to provide the indication of the speed funnel occurring within the sequence of road segments comprises program code instructions to provide the confidence of the presence of the speed funnel.

15. A method comprising:
receiving probe data including sensor data from a probe apparatus collected along a sequence of road segments;
determining, from the sensor data, if an indication of a start of road work has been detected;
constructing a Finite State Automata (FSA) for the probe data collected along the sequence of road segments;
determining, in the probe data, sensor data indicative of a sequence of speed limit value observations;
identifying, using the FSA, a speed funnel based on a pattern of speed limit values within the sequence of speed limit value observations; and
providing an indication of the speed funnel occurring within the sequence of road segments for at least one of navigational assistance or at least semi-autonomous vehicle control.

16. The method of claim 15, wherein the speed funnel includes a starting location within the sequence of road segments and an ending location within the sequence of road segments.

17. The method of claim 15, wherein the pattern of speed limit values within the sequence of speed limit value observations comprises:
a first speed limit value at a first location along the sequence of road links;
a second speed limit value at a second location along the sequence of road links;
a third speed limit value at a third location along the sequence of road links; and
a fourth speed limit value at a fourth location along the sequence of road links,
wherein the second speed limit value is at least a predetermined value below the first speed limit value, the third speed limit value is at least the predetermined value below the second speed limit value, and the fourth speed limit value is equal to or greater than the first speed limit value.

18. The method of claim 17, further comprising:
determining the first location to be a starting location of the speed funnel; and
determining the fourth location to be an ending location of the speed funnel.

19. The method of claim 17, wherein the pattern of speed limit values within the sequence of speed limit value observations requires the first location to be within a predefined distance of the second location, the second location to be within a predefined distance of the third location, and the fourth location to be within a predefined distance of the third location.

20. The method of claim 15, wherein determining, from the probe data, if an indication of a start of road work has been detected comprises:
identifying, in the sensor data, an indication of a start of road work, wherein the indication of the start of road work comprises at least one of: a sign or a road work object.
